(19) United States
(12) Patent Application Publication
(10) Pub. No.: US 2020/0083921 A1
(43) Pub. Date: Mar. 12, 2020

(54) MOBILE DEVICE MULTI-TOOL

(71) Applicant: Matthew Allen Hogue, Atascadero, CA (US)

(72) Inventor: Matthew Allen Hogue, Atascadero, CA (US)

(21) Appl. No.: 16/564,363

(22) Filed: Sep. 9, 2019

Related U.S. Application Data
(60) Provisional application No. 62/728,943, filed on Sep. 10, 2018.

(51) Int. Cl. H04B 1/3888

(52) U.S. Cl. CPC H04B 1/3888; A45C 2011/002; A45C 2200/15

(57) ABSTRACT

A case for a mobile device is provided comprised of a body defining a device receptacle configured to removably retain the mobile device. A plurality of retention elements can be connected to the body. The retention elements selected from the group include a movable ring, a vehicle vent vane clip, a ball and socket, and an adjustable stand.

### CROSS-REFERENCE TO RELATED APPLICATIONS

This application claims the benefit of U.S. Provisional Patent Application No. 62/728,943 filed on Sep. 10, 2018, entitled “Mobile device Multi-Tool”, which is hereby incorporated by reference in its entirety for all that is taught and disclosed therein.

### FIELD OF THE INVENTION

The present invention relates to a mobile device multi-tool, and more particularly to a case for a mobile device comprised of a body defining a device receptacle configured to removably retain the mobile device with a plurality of retention elements that connect to the body.

### BACKGROUND OF THE INVENTION

With Technology increasing at a rapid pace in today's day and age, mobile devices have become a necessity in daily use. Mobile device references are: cell phones, tablets, laptops, or any mobile electronic computer system. Though the necessity is there, the functionality over a variety of uses has become cumbersome in the way a device is held, propped, hung, or retained in any which way. The limitations of the prior art are addressed by providing a case for a mobile device comprised of a body defining a device receptacle configured to removably retain the mobile device. A plurality of retention elements can be connected to the body. The retention elements selected from the group include a movable ring, a vehicle vent vane clip, a ball and socket, and an adjustable stand.

### BRIEF DESCRIPTION OF THE DRAWINGS

FIGS. 1A-5B show various views of a preferred embodiment of the invention.

### DETAILED DESCRIPTION OF A PREFERRED EMBODIMENT

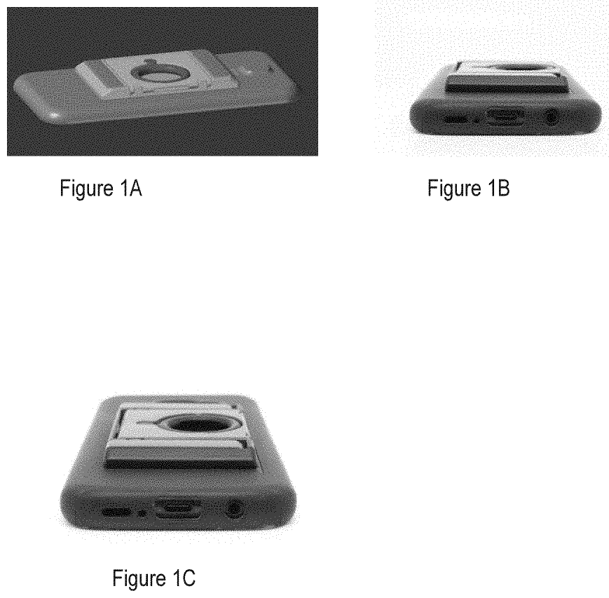

FIGS. 1A-1C illustrate an example of a mobile device with no case utilizing the attachment installed by adhesion. It showcases the slim sleek design which keeps itself from getting hung up on foreign objects.

FIGS. 1B-1C illustrate an example of a mobile device with a case that has the multi-tool attachment installed by adhesion. This also gives a visual of how the multi-tool/single tool vent clip/clips can be integrated into mobile device cases. The case would have to become slightly thicker to allow room of the multi-tool design/single tool vent clip/clips to be built into the case. When either design is built into mobile device cases, the overall product would become better due to the overall thickness being thinner while being an all in one integrated unit.

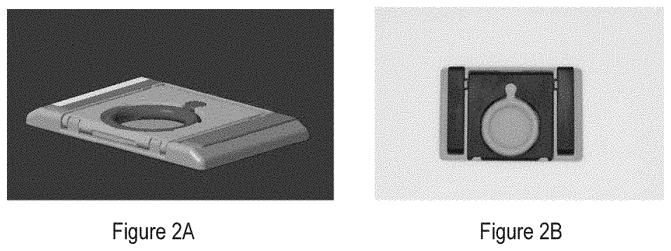

FIGS. 2A-2B show the attachment standing alone as its own integrated unit. It depicts some of the multi-tool options such as: a ball socket finger ring, kickstand/kickstands, and built-in hands-free attachment (vent clip/clips).

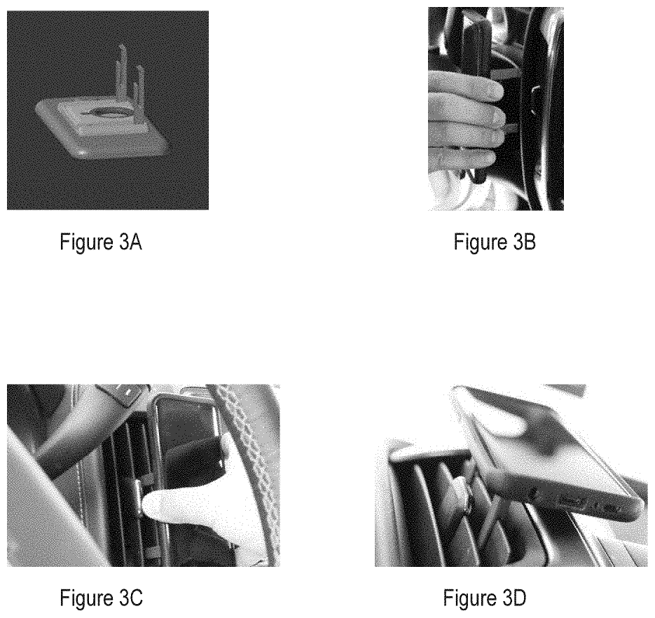

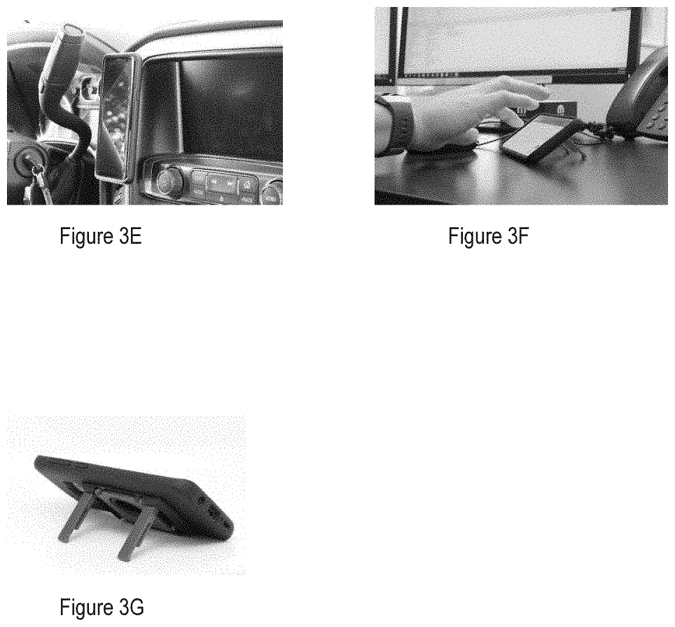

FIGS. 3A-3G show the utility of the integrated hands-free vent clips/clip in multi-tool attachment form for your vehicle vents. These vent clip/clips hold onto the vehicle vents by their own resiliency while holding a mobile device without any supplemental attachment support. This tool is unique to itself due to it having validity as its own single tool attachment by adhesion or being built into a mobile device case as a single use tool. This tool allows the user to use their hands-free option for their mobile device in any vehicle at any time without another attachment. The vent clip/clips also double as another unique kickstand while offering complete stability of the mobile device while typing/viewing purposes. This type of kickstand is completely unique due to its ability to withstand hard shock or contact without falling over.

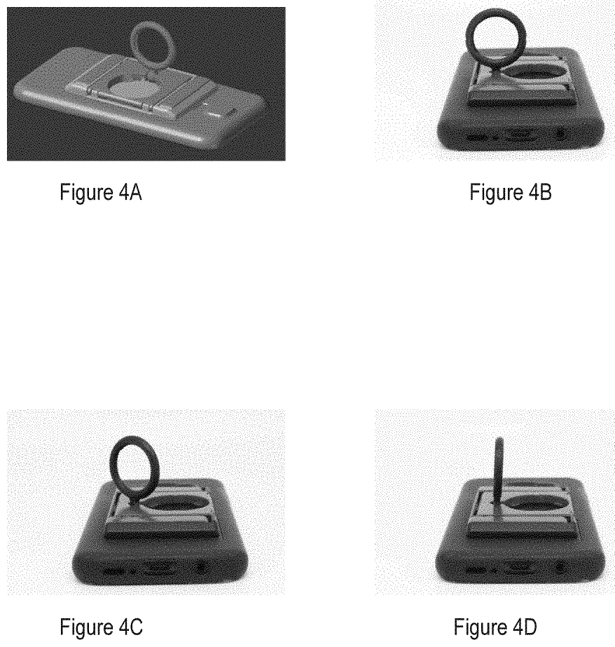

FIGS. 4A-4D show the ring rotated out of its home position, providing the ability for a user to have a secure hold on a mobile device without restriction to the mobile device. The ring has a ball socket design which enables the user to move their hand in any which way being: a rotation, up, down, lateral, circular, or diagonal without restriction other than its own interference. The only restriction is the hard boundaries of the ring itself against the attachment/case.

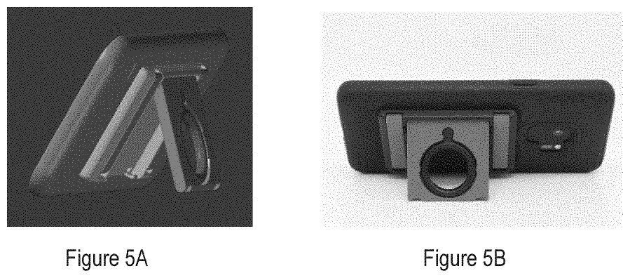

FIGS. 5A-5B show the kick stand extended out which enables the user to prop their mobile device with ease. This allows a multitude of uses without having to physically hold or prop the mobile device by any object. The wide stand allows for great stability in comparison to the variety of sizes of mobile devices. The ring is retained in the kick stand by five points of contact as well as the coefficient of friction.

This mobile device invention is unique due to its two or more feature/tool options in one integrated system. The invention is also unique due to its self-integrated hands-free feature, being that the hands-free clip/clips are able to attach to the vent/vents of your vehicle without any other supporting device/accessory. This feature can stand alone as its own accessory/attachment, be integrated into the multi-tool accessory attachment with two or more feature options, or be a stand-alone utility that is built into a mobile device case. This invention is intended to be scaled to different sizes for its corresponding mobile device in which it may contain a different variety of integrated features/tools. A tool description is: component/components that are used in any way that benefit the user by way of simplifying the operation/operations during the use of a mobile device by assisting in the way a mobile device is held, propped, hung, or retained in any which way.

The multi-tool design of this invention is intended to be utilized on two different spectrums. The first being a stand-alone multi-tool in an attachment/accessory form, in which it has a slim sleek design to keep itself from catching on any foreign objects while attached by adhesion. The second being a case for a mobile device with the multi-tool invention built into it. Features of the multi-tool are but not limited to: a unique ball socket finger ring to enhance the stability and security of the device, a hand strap to hold a mobile device securely, vent clips that hold your mobile device to a vehicles vent/vent's by its own resiliency, kick stand/kick stands to prop your mobile device during use in any manner, and hooks that allow you to hang your mobile device from a desired area. Any chosen features are retained in one unit, being either a stand-alone attachment/accessory or integrated into a mobile device case. The assembly of the features being a stand-alone attachment/accessory or the integrated mobile device case is by snap design, coefficient of friction, and or attached by hardware.

The incorporated finger ring is unique to itself, due to having a ball socket design. This ball socket design allows the user to move their hand and rotate the mobile device in any which direction without restriction to the mobile device. Due to the vent holders being integrated into the stand-alone attachment/multi-tool attachment/mobile device case, it allows the ability for a user to take your hands-free option in any vehicle without having to take along an additional attachment. The integrated kickstand/kickstands gives the option for the user to prop there mobile device for any use. The integrated hooks give the option to hang a mobile device on an object in order to gain height, better visibility, or for a hands-free function.

This invention in attachment form universally adapts to mobile devices by adhesion.

The invention is more unique in mobile device case form due to the, multi-tool/stand-alone hands-free vent clips/clip, design integrated in a single slimmer unit. In case form, per mobile device variant, there will be a variety of integrated cases needed due to the vast numbers of mobile device shapes and sizes.

I claim:

1. A case for a mobile device comprising:
a body defining a device receptacle configured to removably retain the mobile device;
a plurality of retention elements connected to the body; and
the retention elements selected from the group including:
a movable ring;
a vehicle vent vane clip;
a ball and socket;
an adjustable stand.
